(19) United States
(12) Patent Application Publication
(10) Pub. No.: US 2022/0251460 A1
(43) Pub. Date: Aug. 11, 2022

(54) METHODS OF PREPARING NAPHTHENIC PROCESS OIL VIA EXTRACTION AND SEPARATION

(71) Applicant: HOLLYFRONTIER LSP BRAND STRATEGIES LLC, Dallas, TX (US)

(72) Inventors: Mackenzie Carder, Tulsa, OK (US); Karissa Mooney, Media, PA (US)

(73) Assignee: HOLLYFRONTIER LSP BRAND STRATEGIES LLC, Dallas, TX (US)

(21) Appl. No.: 17/170,505

(22) Filed: Feb. 8, 2021

(51) Int. Cl. C10G 53/04

(52) U.S. Cl. CPC C10G 53/04; C10G 2300/304; C10G 2300/308; C10G 2300/302

(57) ABSTRACT

The methods described herein produce a naphthenic process oil, as classified by ASTM D-2226, containing 35-65% saturates and 35-65% aromatics as determined by ASTM D-2007. The produced naphthenic process oil also contains polyaromatic hydrocarbons (PAH), more specifically the EU/US EPA 8-regulated PAHs, less than 10 ppm. The naphthenic process oil is produced by first feeding gas oil ranging in viscosities up to 20 cSt at 100° C. through counter-current liquid-liquid extraction towers with a solvent having a selective affinity for aromatics. The extract is then cooled and either continuously processed through a coalescing separator or batch processed in a tank or decanter to produce a second raffinate, which can be further distilled to produce the naphthenic process oil.

### BACKGROUND

This present disclosure relates to a process for the production of naphthenic process oils containing 35-65% saturates and 35-65% aromatics and with a content of regulated polyaromatic hydrocarbons (PAH) less than 10 ppm. Process oils are hydrocarbon mixtures produced from petroleum used as plasticizers or extenders in the production of rubber, polymers, asphalt, and other industrial resources/products.

The eight regulated PAH compounds are as follows: benzo(a)anthracene, chrysene, benzo(b)fluoranthene, benzo(j)fluoranthene, benzo(k)fluoranthene, benzo(e)pyrene, benzo(a)pyrene, and dibenzo(a,h)anthracene. These compounds are regulated by the European Union's Registration, Evaluation, Authorisation and Restriction of Chemicals (REACH) directive. The 8 regulated PAH compounds are also the 8 PAHs identified and quantified via the European Standard EN 16143:2013 GCMS method. Previously, the level of carcinogens in a process oil was determined by the amount of polycyclic aromatic (PCA) compounds using method IP-346. The limit on PCAs is less than 3% weight, which is understood to be equivalent to the 10 ppm limit set on the 8 PAH compounds measured in the EN 16143: 2013 method.

The naphthenic process oils discussed herein pertain to the polymer and rubber industry in the following manner. Petroleum oils are added to polymers during manufacturing as an extender oil or to a rubber compound as a process oil. These oils are used in the rubber industry as a process aid by lowering the viscosity, allowing for compounding and manufacturing. Process oils are also used to improve performance properties in the final rubber products. Rubber process oils are classified as paraffinic, naphthenic, or aromatic based on the hydrocarbon makeup and majority of aromatic or saturated ring structure. Specifically, four classes of rubber petroleum oils are defined by industry standard (ASTM D-2226) as based on asphaltene, polar compounds, and saturated hydrocarbons concentrations. The properties are determined by another industry standard method (ASTM D2007—“Standard Test Method for Characteristic Groups in Rubber Extender and Processing Oils and Other Petroleum-Derived Oils by the Clay-Gel Absorption Chromatographic Method”), which is a clay and silica gel lab extraction process. Type 101 is the highest in asphaltenes, least saturated, and most polar and type 104 is the lowest in asphaltenes, most saturated, and least polar. The process oils described further herein are type 103, naphthenic rubber process oils.

The classification of the process oil determines the compatibility of the oil with the polymer system. The efficiency in reducing the viscosity and effectiveness of altering the physical properties of the rubber is dependent on the degree of solubility in the polymer. The driving principle of solubility is that “like dissolves like”, which applied to polymers means aromatic oils are compatible with polymers of low polarity such as SBR and BR. As aromaticity decreases in the process oil the solubility factor changes for each rubber type or polymer. Naphthenic oils are highly compatible with EPDM and isoprene and moderately compatible with SBR and BR.

There is a need for aromatic oils in the rubber, specifically tire, industry due to the compatibility with the polymers used. Most highly aromatic oils such as DAE (Distillate Aromatic Extracts) contain carcinogenic compounds consisting of 8 PAH. After studies showed that majority of the PAH emissions from tires were contributed to the process oils, the European Union implemented the REACH directive prohibiting the use of extender oils containing a level of 8 regulated PAH compounds above 10 ppm. Additionally, benzo(a)pyrene must be less than 1 ppm. Tire companies since have been converting to environmentally sound oils, such as Treated Distillate Aromatic Extract (TDAE), MES, naphthenic oils and some Residual Aromatic Extract (RAE), which could require expensive process changes and capital investments.

The naphthenic process oils described further herein also pertain to the asphalt industry, as well as other industries. The naphthenic oils are generally used to modify asphalt binders to enhance their low temperature performance properties or function as a rejuvenator to increase the amount of recycled asphalt pavement (RAP) in an asphalt mix design.

Former methods for producing naphthenic process oils involved hydrotreatment of a heavy vacuum petroleum distillate, which is produced by distilling a naphthenic crude oil in a series of distillation towers. The hydrotreatment process converts the polycyclic aromatics into naphthenes, which removes the carcinogenic compounds. Hydrotreatment requires a chemical reaction using hydrogen in the presence of a catalyst. A constant supply of pure (>90%) hydrogen is necessary, therefore a hydrogen plant is needed in order to produce naphthenic oils in this method. The capital and energy costs associated with building and operating a hydrogen plant and hydrotreatment unit is very high. Catalyst must also be replaced every few years requiring a unit shutdown that would interrupt production.

Other methods involve multiple steps of hydrotreatment including catalytic dewaxing and hydrofinishing. Catalytic dewaxing (a form of hydrocracking) removes wax molecules in a petroleum feed by contacting the feed with hydrogen in the presence of a dewaxing cracking catalyst. Hydrofinishing is the process of reacting the feed with hydrogen in the presence of a catalyst at less severe conditions than hydrotreatment and hydrocracking. These methods are expensive and require a lot of expensive equipment and maintenance. This method does not allow for the production of wax products that can be very lucrative in different industries.

International Patent Publication No. WO 2016/183200A1 describes a method to produce a naphthenic process oil by blending naphthenic gas oils and hydrotreating. The steps may be reversed as well by blending hydrotreated naphthenic gas oils. International Patent Publication No. WO 2016/044637A1 also describes a process for hydrotreating naphthenic base oils to produce an oil with improved low temperature properties. These methods require the use of naphthenic feeds and some form of hydrotreatment to produce a naphthenic oil. This requires large capital investments and specific feed stocks, which can be difficult to find in certain environments.

### SUMMARY

The present disclosure pertains to methods for producing naphthenic process oils without the capital and energy intensive requirements of hydrotreatment process units. The methods also allow for the production of waxes and base oils using the same petroleum feed. The feed does not need to be naphthenic to produce the final naphthenic oil. Another objective is to produce environmentally safe process oils, in accordance with the EU directive, containing less than 10 ppm of the 8 regulated PAH compounds. This permits usage in tire production and is becoming the preference in other industries, such as rubber, polymer, and asphalt production.

The processes described herein involve liquid-liquid solvent extraction, used advantageously to produce naphthenic process oils. Solvent extraction has been used to upgrade gas oils into lubricating oils, waxes, aromatic process oils, and others. The process includes feeding a selective solvent to the top of the extraction tower and a gas oil to the middle or bottom to run counter-current. A paraffinic raffinate is pulled from the top and a relatively aromatic extract is pulled from the bottom. This method is used to produce the DAE oil, described above, that is the aromatic extract. Usually the aromatic extract along with the majority of the solvent is cooled and sent to a separator where further adsorption occurs. The top phase, called a pseudo-raffinate, is circulated back to the extraction towers to help increase the raffinate yields. The bottom phase is sent to a solvent recovery section, which then produces the final DAE product.

Multiple stages of extraction are also used where the raffinate phase or the extract phase are processed through a second solvent extraction tower to further upgrade the streams. This method is used to produce a TDAE oil in which either the secondary extract from the re-extraction of the primary raffinate or the secondary raffinate from the re-extraction of the primary extract are the TDAE oils. Certain aspects of these methods are described in European Patent No. 0417980B1, relating to making a process oil, and in European Patent No. 2571961A2, relating to making a TDAE oil. However, the present methods differ from the disclosures of these European patents because the second extraction step occurs in a separatory coalescing vessel, instead of a second extraction tower, before the solvent recovery trains.

### BRIEF DESCRIPTION OF THE DRAWINGS

FIG. 1 shows a general schematic for methods of producing naphthenic process oils according to preferred embodiments disclosed herein.

### DETAILED DESCRIPTION OF PREFERRED EMBODIMENTS

The present disclosure relates to methods for producing naphthenic process oils which are environmentally safe and meet regulations with regard to the amount of regulated polyaromatic hydrocarbons (PAH) they contain. The naphthenic process oils contain 35-65% saturates by weight and 35-65% aromatics by weight and less than 10 ppm of the 8 regulated PAH compounds. The naphthenic process oils are also characterized as containing less than 10 mg/kg of the 8 regulated PAH compounds and less than 1 mg/kg of benzo(a)pyrene and thus can be classified as non-carcinogenic oils.

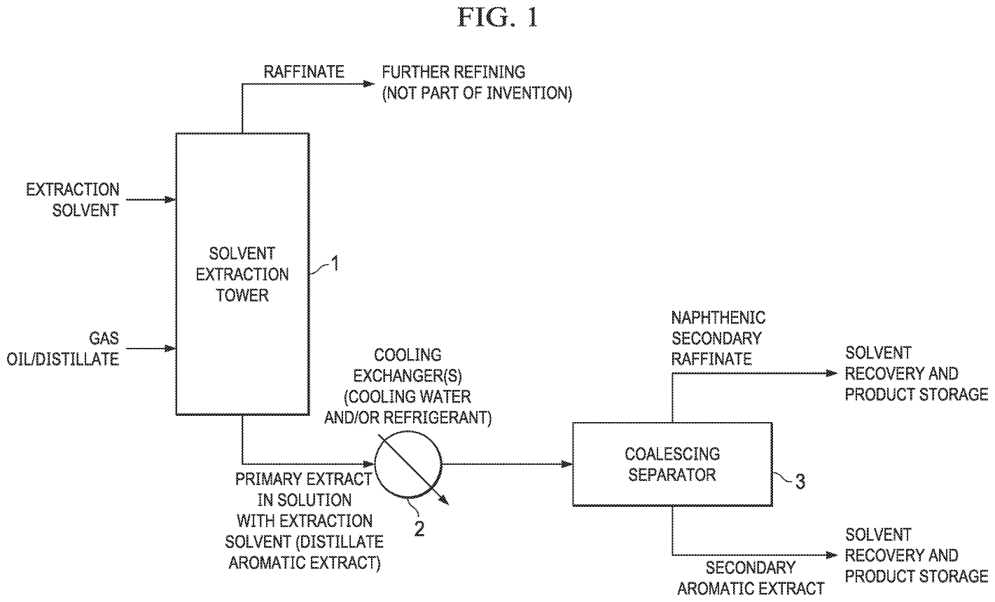

FIG. 1 shows a general schematic for methods of producing naphthenic process oils according to preferred embodiments disclosed herein. The streams in FIG. 1 are labeled generally to show the flow of the process streams and where chemical separations are occurring. FIG. 1 illustrates a generic process and is not intended to limit the invention. Operational changes within this process can be made and are included in the scope of the invention.

Generally, the methods described herein include feeding gas oil (viscosity up to 20 cSt at 100° C.) produced by vacuum distillation of crude oil atmospheric residual bottoms and a solvent selective for aromatic hydrocarbons into a countercurrent liquid-liquid extraction tower. A primary raffinate is produced from the top of the tower and sent for further processing, which can result in profitable waxes and lubricating base oils. The distillate aromatic extract in solution with the extraction solvent produced from the bottom of the tower is then chilled in a cooling water exchanger or other form of chiller. This mixture is then fed to a vessel containing calming baffles and structured packing to aid in the separation/mild second extraction. This produces a secondary extract stream containing heavier aromatics and a pseudo-raffinate stream containing lighter aromatics, naphthenics, and low PAHs. Both product streams then pass through solvent recovery process units to produce solvent-free final products sent to tankage.

In particular, in preferred embodiments, a first step in the method is counter-current solvent extraction. The solvent used is selective for aromatic hydrocarbon compounds, particularly selective for polycyclic aromatics. Therefore, the solvent will separate and adsorb the aromatic compounds, including the PCAs and PAHs. Different solvents are available and capable of performing this separation. These include and are not limited to: furfural, NMP, acetophenone, liquid SO2, acetonitrile, phenol, nitro-benzene, aniline, dimethyl sulfoxide, dimethyl formamide, and mixtures thereof. The solvent is injected into the top of the extraction tower while the gas oil feed is injected into the middle/bottom. Multiple extraction towers can be operated in parallel in order to accomplish the same separation with more feed. Generally the internals of the extraction towers are either rotating circular disks or packing material. The gas oil feed is contacted with the solvent at a temperature ranging from 210° F. to 290° F. at a solvent to oil ratio in the range of 1:1 to 5:1, preferably 2:1 to 4:1. The temperature gradient in the extraction tower(s) is 40° F. to 70° F. depending on the desired extraction severity and the feed composition. The solvent removes the aromatic and naphthenic compounds and exits through the bottom of the tower while the paraffinic raffinate is removed from the top. This raffinate is no longer a part of the methods described herein after it is removed from the gas oil through extraction and sent to a solvent recovery train. This stream preferably has a viscosity index (VI) greater than 90 and is typically further processed by hydrotreatment or de-waxing to produce base oil and wax products. This first raffinate product stream can be further processed in a dewaxing unit that results in the production of a paraffinic base oil and a wax. Generally raffinate yields range from 45% to 80%. Operational controls of the solvent extraction tower(s) depends on the properties of the feed gas oil used, therefore the process conditions should be varied and not identical per different batches or feeds. It is preferable to set operating conditions to produce a raffinate with VI greater than 90.

The solvent extracted aromatics and naphthenics along with the majority of the solvent exit the bottom of the extraction tower(s) to be cooled 10° F. to 150° F. colder than the extractor bottom temperature. The cooling method can vary and examples include cooling water exchangers, process stream coolers, chillers, and a mixture in series or parallel. The colder temperature increases the selectivity of the solvent for aromatic compounds, therefore the colder the exiting stream, the more aromatics will be extracted in the next step. Therefore the exact cooling conditions to produce the desired oil described herein are determined by the concentration of aromatics and PAH compounds in the feed. The yields of each extraction and separation step are dependent on the feed and operating conditions chosen.

In preferred embodiments, the last step involves sending the cooled primary extract-solvent stream to a separator, such as a coalescing separator, to form two immiscible liquid phases. The coalescing separator contains internals comprised of one-stage packed coalescing material that aid in this second separation at the front and baffles for settling in the back. This process is continuous, producing the naphthenic oil and solvent mixture as well as a secondary extract and solvent mixture. Both of these streams are sent to separate solvent recovery trains ending with a final naphthenic oil and a secondary aromatic extract product. The final naphthenic oil in the pseudo-raffinate stream contains between 35% and 65% saturates and aromatics classifying the product as a Type 103 rubber petroleum oil according to industry standard ASTM D-2226. This product also contains PAH compounds less than 10 ppm, which satisfies the EU REACH regulation, making it a safe and non-carcinogenic process oil. The aromatic extract oil contains greater than 65% aromatics, which is classified as a Type 104 process oil. This second extract is a DAE with high PAH, which cannot be sold into the rubber industry due to the high aromatic content. If able, this stream can continue to be used in some rubber or other industrial applications that are not sensitive to carcinogenetic properties, such as the asphalt industry. In the methods described herein, a typical waste stream is converted to a naphthenic process oil that meets specifications and performance characteristics for safe use in rubber, polymers, and asphalt.

In alternate embodiments, gas oil is processed through liquid-liquid solvent extraction just as described above in the first preferred embodiments. The extract along with the majority of the solvent is cooled in a similar fashion to a temperature 10° F. to 150° F. colder than the extractor bottom temperature. Again, the exact cooling conditions to produce the desired oil of this invention are determined by the concentration of aromatics and PAH compounds in the feed so process conditions will vary. The last step consists of sending the extract-solvent stream to a separator, such as a settler, a tank or a decanter, where the two immiscible liquid phases will separate over time. The longer the oils sit, the better the separation will be. Generally, an adequate separation will occur in 24-48 hours. Once an adequate amount of time has passed the top phase containing the naphthenic oil and a small amount of solvent are removed. The two phases are then sent to separate solvent recovery trains producing a final naphthenic oil and a secondary aromatic extract oil.

An alternative step to further aid in the second separation, which takes place in the coalescing separator, settler, tank, or decanter, is the addition of an antisolvent, or solvent modifier, such as water. Adequate antisolvents are almost completely soluble in the extraction solvent and only slightly soluble in paraffinic oils. Water is the preferred antisolvent, but other effective antisolvents include alcohols and glycols. The use of antisolvent is not necessary to achieve the desired results.

Preferred embodiments of the present method do not require hydrotreatment or the use of naphthenic feeds. The primary existing methods for producing naphthenic oils require both of these things, which requires capital and higher operating expenses. One benefit of the present methods is the ability to produce multiple classifications of process oils in one or two processes. Just from the primary extract, 103 and 104 classes of rubber process oils are produced. There are also many options for further refining the primary raffinate. The naphthenic oil produced according to the methods disclosed herein can be used to replace carcinogenic DAE oils due to the low PAH content. This will be useful for both the polymer and rubber industries. The uses of this naphthenic oil are not restricted to any particular industries or products discussed herein.

### EXAMPLE 1

The examples presented herein are not intended to limit the scope of the invention. Exemplary embodiments of the methods described herein are described with reference to the examples.

Various industry standard test methods exist to characterize relevant operating streams and physical properties of the products described herein. Table 1 below provides a list of industry standard test methods used in these examples.

TABLE 1

| Property | Test Method |
|---|---|
| Viscosity (all | ASTM D-445 |
| temperatures) | |
| Density | ASTM D-4052 |
| API | ASTM D-1250 |
| Flash point, COC | ASTM D-92 |
| Refractive Index | ASTM D-1218 |
| Viscosity Gravity | ASTM D-2501 |
| Constant | |
| Pour Point | ASTM D-5949 |
| Refractivity Intercept | ASTM D-2140 |
| Carbon Analysis | ASTM D-2140 |
| Clay Gel, Composition | ASTM D-2007 |
| Simulated Distillation | ASTM D-2887 |
| EN 16143 PAH (ppm) | GCMS |

A crude mixture consisting mostly of West Texas Intermediate was distilled through an atmospheric distillation tower and two vacuum distillation towers to produce varying waxy distillates/gas oils. A bottom cut gas oil produced from the first vacuum tower and a middle cut gas oil produced from the second vacuum tower were chosen as the feeds. The properties of these waxy distillates were determined using the methods in Table 1 and are shown in Table 2 below.

TABLE 2

| Property | Gas Oil #1 | Gas Oil #2 |
|---|---|---|
| Viscosity @40 C. (cSt) | 64.5 | 70.6 |
| Viscosity @100 C. (cSt) | 7.8 | 14.5 |
| Density @15 C. (kg/L) | 0.8998 | 0.9145 |
| API | 25.6 | 23.1 |
| Flash (C.) | 240 | 284 |
| Refractive Index | 1.5002 | 1.5032 |
| Viscosity Gravity | 0.838 | 0.841 |
| Constant | | |
| Pour Point (C.) | 35 | 30 |
| Refractivity Intercept | 1.0519 | 1.0475 |
| ASTM Color | 5.0 | 8.0 |
| Carbon Analysis | | |
| C_{A}, % | 17 | 12 |
| C_{N}, % | 22 | 31 |
| C_{P}, % | 61 | 57 |
| Simulated Distillation | | |
| IBP | 681 | 751 |
| 5% | 771 | 814 |
| 10% | 797 | 836 |
| 20% | 824 | 866 |
| 30% | 841 | 886 |
| 40% | 855 | 904 |
| 50% | 869 | 921 |
| 60% | 882 | 937 |
| 70% | 896 | 955 |
| 80% | 913 | 976 |
| 90% | 937 | 1005 |
| 95% | 957 | 1029 |
| FBP | 1034 | 1105 |

The chosen gas oil (Gas Oil #1 or Gas Oil #2) was fed to three parallel liquid-liquid extraction towers where furfural was the selected solvent. The raffinate product was pulled from the top of the tower, processed through a mild hydrotreater and through a solvent recovery train. The primary raffinate was then sent for further processing. The primary extract and majority of the furfural was pulled from the bottom of the extractor towers and sent through a series of exchangers including a feed-effluent exchanger and a cooling water exchanger. The cooled extract-furfural stream was then sent to a coalescing separator to allow the furfural to further extract the heavy hydrocarbons and PAH compounds. From the coalescer the naphthenic stream containing a small portion of furfural and a secondary extract with the majority of the furfural were both sent to separate solvent extraction trains.

Two different runs using the same feed cut are discussed in this example. The process conditions of the extraction towers and separator for Gas Oil #1 are shown in Table 3. The process conditions of the extraction towers and separator for Gas Oil #2 are shown in Table 5. The resulting products of the invention separations were a primary raffinate, naphthenic oil, and an aromatic extract. The yields and physical properties of the subsequent products are shown in Table 4 and Table 6, respectively.

TABLE 3

| Process Conditions-Gas | | |
|---|---|---|
| Oil #1 | Run #1 | Run #2 |
| Extractor top temperature | 250 | 245 |
| Extractor bottom temperature | 175 | 175 |
| Solvent to oil ratio | 3.0 | 3.0 |
| Separator temperature | 145 | 100 |

TABLE 4

| | Run #1 | | | Run #2 | | |
|---|---|---|---|---|---|---|
| | Primary | Aromatic | | Primary | Aromatic | |
| Property | Raffinate | Extract | Naphthenic | Raffinate | Extract | Naphthenic |
| Yield | 70% | 26% | 4% | 68% | 24% | 8% |
| Viscosity | — | 663.3 | 66 | — | 558.1 | — |
| @40 C. (cSt) | | | | | | |
| Viscosity | — | — | 26.5 | — | — | — |
| @60 C. (cSt) | | | | | | |
| Viscosity | 6.5 | 17.1 | 7.7 | 6.5 | 16.9 | 9.0 |
| @100 C. (cSt) | | | | | | |
| Density | — | 0.9812 | 0.9040 | — | 0.9842 | 0.9156 |
| @15 C. (kg/L) | | | | | | |
| API | 31.46 | 12.57 | 24.83 | 31.19 | 12.14 | 22.89 |
| Flash (C.) | — | 238 | 236 | — | 226 | — |
| Refractive | — | 1.5550 | 1.4988 | — | 1.5570 | 1.5060 |
| Index | | | | | | |
| Viscosity | — | 0.932 | 0.844 | | 0.938 | 0.854 |
| Gravity | | | | | | |
| Constant | | | | | | |
| Pour Point | — | 9 | | — | 3 | 25 |
| (C.) | | | | | | |
| Refractivity | — | 1.0660 | 1.0480 | — | 1.0665 | 1.0497 |
| Intercept | | | | | | |
| Aniline Point | 113.4 | 38.9 | 88.6 | 111.9 | 36.9 | 82.8 |
| Carbon | | | | | | |
| Analysis | | | | | | |
| C_{A},% | — | 39 | 13 | — | 39 | 16 |
| C_{N}, % | — | 25 | 32 | — | 27 | 30 |
| C_{P},% | — | 36 | 55 | — | 34 | 54 |
| Clay Gel, | | | | | | |
| Composition | | | | | | |
| Aromatics | — | 72 | 39 | — | 75 | 50 |
| Polars | — | 9 | 2 | — | 9 | 4 |
| Saturates | — | 19 | 59 | — | 16 | 46 |
| EN 16143 | 0 | 273 | 6.5 | 0 | 262 | 8.3 |
| PAH (ppm) | | | | | | |

TABLE 5

| Process Conditions-Gas | | |
|---|---|---|
| Oil #2 | Run #1 | Run #2 |
| Extractor top temperature | 280 | 280 |
| Extractor bottom temperature | 210 | 215 |
| Solvent to oil ratio | 3.75 | 3.85 |
| Separator temperature | 165 | 110 |

TABLE 6

| | Run #1 | | | Run #2 | | |
|---|---|---|---|---|---|---|
| | Primary | Aromatic | | Primary | Aromatic | |
| Property | Raffinate | Extract | Naphthenic | Raffinate | Extract | Naphthenic |
| Yield | 54% | 35% | 11% | 54% | 28% | 18% |
| Viscosity | — | 288.1 | | — | 365.9 | |
| @60 C. (cSt) | | | | | | |
| Viscosity | 10.6 | 32.8 | 15.2 | 10.6 | 36.9 | 16.5 |
| @100 C. (cSt) | | | | | | |
| Density | — | 0.9775 | 0.9170 | — | 0.9841 | 0.9233 |
| @15 C. (kg/L) | | | | | | |
| API | 30.42 | 13.06 | 22.71 | 30.28 | 12.14 | 21.61 |
| Flash (C.) | — | 277 | 268 | — | 259 | |
| Refractive | — | — | 1.5079 | — | — | 1.5097 |
| Index | | | | | | |
| Viscosity | — | — | 0.842 | — | — | 0.849 |
| Gravity | | | | | | |
| Constant | | | | | | |
| Pour Point | — | 18 | 36 | — | 11 | 32 |
| (C.) | | | | | | |
| Refractivity | — | — | 1.0510 | — | — | 1.0496 |
| Intercept | | | | | | |
| Aniline Point | 122.7 | — | 94.0 | 122.5 | — | 89.8 |
| Carbon | | | | — | | |
| Analysis | | | | | | |
| C_{A},% | — | — | 16 | — | — | 15 |
| C_{N}, % | — | — | 25 | — | — | 29 |
| C_{P},% | — | — | 59 | — | — | 56 |
| Clay Gel, | | | | — | | |
| Composition | | | | | | |
| (wt %) | | | | | | |
| Aromatics | — | 67 | 42 | — | 69 | 52 |
| Polars | — | 12 | 4 | — | 12 | 6 |
| Saturates | — | 21 | 54 | — | 19 | 42 |
| EN 16143 | — | 64.7 | 3.6 | — | 90.0 | 2.3 |
| PAH (ppm) | | | | | | |

As seen in Table 4, the naphthenic oil produced from Gas Oil #1 contained, in Run #1, 39 wt % aromatics, 59 wt % saturates, and 6.5 ppm of the 8 regulated PAH compounds, and in Run #2, 50 wt % aromatics, 46 wt % saturates, and 8.3 ppm of the 8 regulated PAH compounds. As seen in Table 6, the naphthenic oil produced from Gas Oil #2 contained, in Run #1, 42 wt % aromatics, 54 wt % saturates, and 3.6 ppm of the 8 regulated PAH compounds, and in Run #2, 52 wt % aromatics, 42 wt % saturates, and 2.3 ppm of the 8 regulated PAH compounds.

1. A process for producing a naphthenic process oil, a primary paraffinic raffinate, and an aromatic secondary extract, comprising:
feeding a hydrocarbon gas oil and an extraction solvent selective for aromatic hydrocarbons into a counter-current liquid-liquid extraction tower;
performing counter-current solvent extraction of the hydrocarbon gas oil to produce a primary paraffinic raffinate and a primary extract, wherein the primary extract contains aromatic and naphthenic compounds separated and absorbed by the extraction solvent;
collecting the primary extract;
cooling the primary extract to produce a chilled primary extract;
feeding the chilled primary extract to a separator for separation of the aromatic and naphthenic compounds in the chilled primary extract, wherein the separator is free of antisolvent during the separation;
allowing the chilled primary extract to sit in the separator for an adequate period of time to allow the chilled primary extract to separate into two immiscible liquid phases, wherein the two immiscible liquid phases are a secondary raffinate and a an aromatic secondary extract, wherein the secondary raffinate contains naphthenic oil and solvent, and wherein the aromatic secondary extract is an aromatic process oil comprising aromatics greater than 65% by weight and solvent; and
removing the solvent from the secondary raffinate by distillation to produce a naphthenic process oil.

2. The process of claim 1, wherein the naphthenic process oil comprises 35 to 65% saturates by weight and 35 to 65% aromatics by weight.

3. The process of claim 1, wherein the naphthenic process oil comprises less than 10 mg/kg of benzo(a)anthracene, chrysene, benzo(b)fluoranthene, benzoe(j)fluoranthene, benzo(k)fluoranthene, benzo(e)pyrene, benzo(a)pyrene, and dibenzo(a,h)anthracene and less than 1 mg/kg of benzo(a)pyrene.

4. The process of claim 1, wherein the hydrocarbon gas oil is distilled from crude oil and has a kinematic viscosity within a range of 0 cSt to 20 cSt at 100° C.

5. The process of claim 1, wherein the extraction solvent is selected from the group consisting of furfural, N-methyl-2-pyrrolidone, acetophenone, liquid SO2, acetonitrile, phenol, nitro-benzene, aniline, dimethyl sulfoxide, dimethyl formamide and mixtures thereof.

6. (canceled)

7. (canceled)

8. The process of claim 1, wherein the separator is a coalescing separator.

9. The process of claim 1, wherein the separator is a settler, a tank or a decanter.

10. The process of claim 1, wherein the counter-current liquid-liquid extraction tower has a top portion and a bottom portion, and wherein the top portion has a temperature in a range of 200° F. to 350° F. during the counter-current solvent extraction and wherein the bottom portion has a temperature in a range of 100° F. to 300° F. during the counter-current solvent extraction.

11. The process of claim 1, wherein the hydrocarbon gas oil and the extraction solvent fed into the counter-current liquid-liquid extraction tower have a ratio of extraction solvent to hydrocarbon gas oil ranging from 1:1 to 5:1.

12. The process of claim 1, wherein the primary raffinate has a viscosity index of at least 90.

13. (canceled)
